(19) United States
(12) Patent Application Publication
(10) Pub. No.: US 2004/0021690 A1
(43) Pub. Date: Feb. 5, 2004

(54) Global fabric tracking method and apparatus

(76) Inventors: Steve DeFranco, Slingerlands, NY (US); William A. Haverinen, Queensbury, NY (US); Thomas H. Curry, Saratoga Springs, NY (US)

Correspondence Address: FROMMER LAWRENCE & HAUG, 745 FIFTH AVENUE- 10TH FL., NEW YORK, NY, 10151, US

(21) Appl. No.: 10/209,442

(22) Filed: Jul. 31, 2002

(51) Int. Cl. G09G 5/00

(52) U.S. Cl. 345/772

(57) ABSTRACT

A graphical interface that enables a user to view the exact inventory status of machine clothing for a particular paper machine or a set of paper machines comprising a mill or corporation. A collection of machine positions forms the profile of a machine along the horizontal axis of a table or diagram. A collection of icons represent different items of inventory for each machine position and are included along the vertical axis. Repositioning the items and changing their design represents changes in the machine's status or the status of the inventory for that machine. The user has control over the default settings on the diagram and can show or hide information as needed. The user is able to control the information displayed on the diagram which then controls the actual manufacturing, logistics and inventory control situation for the machine's inventory items. Each icon is linked to it's representation in an Enterprise Resource Planning system and other information gathering systems.

### BACKGROUND OF THE INVENTION

This invention relates to the field of sorting, collecting and processing relevant information regarding the inventory used in the paper manufacturing process, particularly to the sorting and collecting of machine clothing data, including statistical data and the processing of specification updates such as performance statistics and/or other information supplied by the product's user.

Paper manufacturers typically experience difficulty tracking the inventory of materials used in the papermaking process and additional difficulty in tracking the performance of the materials as they are used in the papermaking process. Employees must often devote large amounts of time and resources manually performing these processes. Even if the materials are adequately tracked, follow-up procedures and statistical analysis are all performed by hand and require significant time investment.

In a manufacturing process, inventory generally refers to raw materials, partially completed materials or finished goods which are passed through or added to the item being manufactured. In the past, manual/paper documentation or automated computer systems were used to track all required or created inventory in the manufacturing process. Updates to the status of items were received through phone calls, paper documentation or use of computerized systems that displayed data in tabular text or “report” format.

Currently, paper manufacturing companies typically receive hundreds of pieces of paper machine clothing each year which are delivered to myriad mills and are installed on an even larger number of paper manufacturing machines, under their ownership—mills which can be scattered nationwide or worldwide. These fabrics, all of which have a high dollar value, are absolutely essential to the papermaking process which cannot be run without them. All papermaking companies use paper machine clothing and all typically have a completely different and unique way of tracking a piece's location and subsequent performance.

These current methods include from paper-based and manually maintained note books in which each inventory piece is listed and its current status updated. Some companies have progressed to computerized tracking systems based on those paper models and employing electronic databases. However, none of these systems provide a graphical inventory view or an analysis capability.

The paper based methods (and many of the computerized versions as well) do not permit the analysis needed to properly maintain optimized inventory levels nor perform any of the new performance and value analysis techniques necessary to properly use the advanced engineered products. For example, the invention in accordance with this application permits the searching of the entire database for like products which can be substituted in case of an emergency or which can provide references of successful product use in the case of new “untried” product applications. The user is enabled and authorized to perform myriad analysis techniques on the data stored.

As stated earlier, none of the prior art applications have the userfriendly and more efficient graphical interface as the main user tool or contain the analysis toolsets which enable the user to use the products to their best advantage. The tracking and analysis process is quite expensive and receives less and less attention as companies are forced to place resources elsewhere—just as the complexity of the machine clothing is increasing and the productivity requirements and level of competitiveness of papermakers are reaching new heights.

Moreover, once a piece of machine clothing has been used, these highly engineered products can be analyzed in a lab and their performance characteristics reviewed in order to help better design the next ones to be used. This process is very time consuming, but essential, to the paper manufacturing process. Ineffective fabric design, which cause a paper machine to perform sub-optimally or even be unable to manufacture paper, or failure in the machine clothing tracking system can cause a machine to sit idle, causing loses of up to $25,000 an hour (for a large paper machine).

Therefore, there exists the need to improve the existing process of sorting, collecting and analyzing information about machine clothing inventory and fabric run performance characteristics such that fewer machines are idled by insufficient inventory and so that machine clothing performs at an optimum and most economically beneficial level.

### SUMMARY OF THE INVENTION

The present invention provides a graphical user interface for quickly determining the exact status of inventory on a paper machine and for tracking the performance of that clothing as it is running and after its operational life. This structure is much more flexible, user-friendly and provides an extremely fast, pictorial overview of the status of dozens or hundreds of items in one simple view.

This invention provides much more information and is much easier to use than current methods employed. The invention helps automate the process of machine clothing tracking and analysis from before the fabric manufacturing process has even begun until after the fabric has run and is being analyzed in a laboratory.

This invention employs a labeling scheme in which graphical icons are used at all levels, from displaying all of the paper machines located in a particular corporation, to those located in a particular mill, to all the inventory items located anywhere that relate to each and every paper machine available.

It is often difficult for departments such as engineering, production and procurement within a paper company to properly track the use of machine clothing. Additionally, it has historically been very difficult for these departments to then request and receive the myriad documentation regarding the product.

For example, all machine clothing has volumes of documentation that can accompany it from product summary information to technical reference information to manufacturing specification data. This documentation, although available through the mail or on the Internet, was not easily connected to a particular piece of machine clothing. This invention, using the graphical machine interface, provides links to this information in a simple manner.

Viewing and being able to manipulate the data in this way enables the user to better apply the machine clothing to their particular application and helps increase the production efficiencies and capacities at each mill site. Currently, this information is difficult to collect (takes too much time or requires too much expertise) or its simply not available.

The present invention provides a method for collecting and tracking information about specific pieces of paper machine clothing. First, the tracking record for the machine diagram is created upon receipt of an order. At this point, the diagram displays the order through a specific graphical icon and then links that order icon to all of the relevant information of use to the user including prior run references, profiles, manufacturing specifications, usage documentation and more.

Using any internet-capable browser running on a personal computer or other computer terminal, the user can sign on with a secure username and password and access the machine diagrams for their corporation or mill. These diagrams, for each machine, provide this inventory and post-run information as available. The user can also enter relevant information to the inventory record which is then validated and accepted (or rejected in some cases) by the system for use in processing and updating all item related records.

The information entered by the user is then passed through this invention to the underlying source system be it Enterprise Resource Planning (ERP) or other underlying operational system. The invention then acts as the interface to the information which was entered.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a block diagram illustrating an embodiment of the invention for collecting and processing inventory information;

FIG. 2 is a flow chart illustrating an embodiment of the invention for utilizing and analyzing said inventory information;

FIG. 3 is a block diagram illustrating a hardware configuration of the preferred embodiment of the invention;

FIG. 4 is a flow chart illustrating a preferred embodiment of the invention for collecting run performance information;

FIG. 5 is a flow chart illustrating a portion of a query form for requesting various product applications in accordance with the invention;

FIG. 6 is a graphical representation of a user interface in accordance with an embodiment of the invention;

FIG. 7 is a selection diagram depicting hide/view selections that may be selected by a user to change the user interface display in accordance with the invention;

FIG. 8 is a graphical representation of a user interface in accordance with the invention in which additional information is shown corresponding to the selection of a plurality of selections of FIG. 7;

FIGS. 9A and 9B depict click through information available by selecting one or more links from FIG. 8; and

FIGS. 10A and 10B depict additional click through information available by selecting one or more links from FIG. 8.

### DETAILED DESCRIPTION OF THE INVENTION

A method and apparatus for graphically tracking paper machine clothing inventory is described. In the following in description, numerous specific details are set forth in order to provide a more thorough understanding of the present invention. It will be apparent, however, to one skilled in the art, that the present invention may be practiced without these specific details. In other instances, well-known features have not been described in detail in order not to unnecessarily obscure the present invention.

The method involves two activities, collecting and processing clothing production and use data. Some collection is implemented through Electronic Data Interface (EDI) type system-to-system communication and some through human/manual interaction. Both can coexist in this invention and operate in parallel.

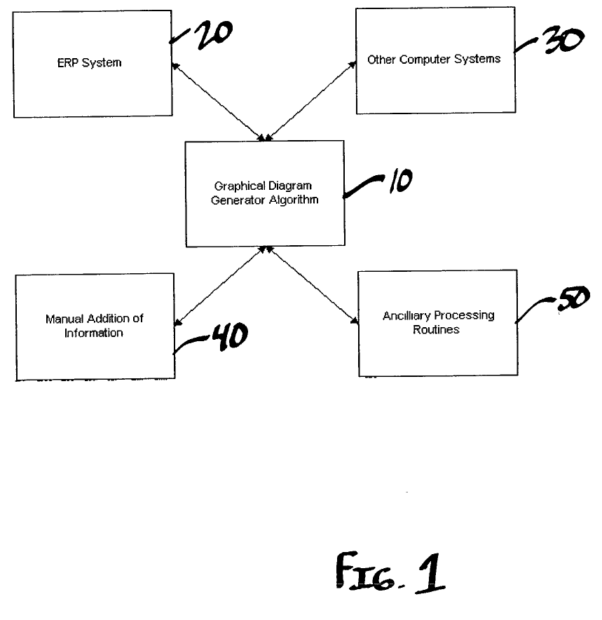

FIG. 1 is a block diagram illustrating an embodiment of the invention for collecting and processing inventory information in accordance with the Global Fabric Tracking System (GFTS) of the invention. As is shown in FIG. 1, a Graphical Diagram Generator Algorithm 10 is depicted coupled with various auxiliary systems. Graphical Diagram Generator Algorithm 10 is constructed in accordance with the invention and allows a graphical interface to be provided to a user for all features in accordance with the invention. Coupled with the Graphical Diagram Generator Algorithm 10 is ERP entry system 20 or other computer systems 30, that may be utilized for the automated and computerized entry of information into the calculation system. As is additionally shown, manual addition of information 40 may be provided allowing for yet another alternative for entering information into the system in accordance with the invention. Finally, various additional calculations in ancillary processing routines 50 may be utilized by graphical diagram generator algorithm 10 as required.

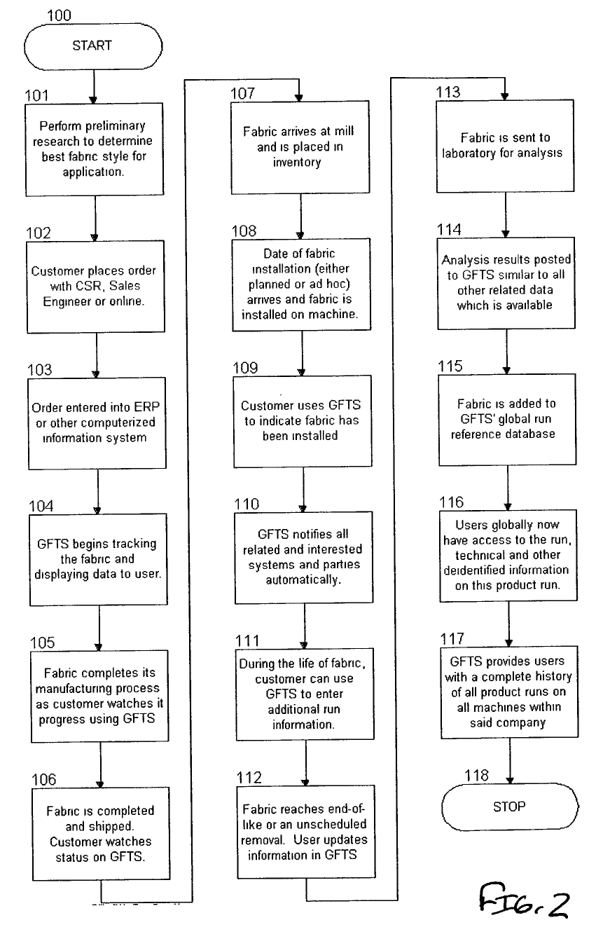

Referring next to FIG. 2, the functioning of Graphical Diagram Generator Algorithm 10 and accompanying data collection process including steps 102 through 117 will now be described. The process begins in step 100. In step 101, the user conducts an analysis, with the help of company and other experts, to determine the best product, including custom modifications, for their particular application. In step 102, the user places an order for the desired engineered product in one of several ways. These include via a Customer Service Representative (CSR), a Sales Engineer, or online. In step 103, after the order is screened for errors and is confirmed as applicable to indicated application, the order is formally allowed to flow into the product scheduling and tracking application, ERP or otherwise.

In step 104, the GFTS notices the existence of this new order and adds it and all related links to the machine diagram. As the fabric traverses the manufacturing process, the diagram and information regarding the item are continuously updated in accordance with the invention. In addition, the user can use the GFTS representation of the fabric to perform certain analysis and reference list creation in preparation for application of the fabric in their environment.

In steps 105 and 106, the fabric completes the manufacturing process and is ready to ship to the customer. The GFTS then represents the fabric as in transit using a different graphical icon on the user interface (as will be shown below). The customer, using GFTS directly or requesting GFTS for an automatic notification will be alerted to fabric shipment. The automatic notification of fabric shipment links the user directly back to the profile and additional information available in GFTS.

In step 107, the fabric arrives at the mill and is placed in inventory for later usage. The customer can use the GFTS to obtain all characteristics of the product without having to locate the product in inventory. Using GFTS, the user can also determine the installation order of all fabrics in inventory and use all the available information on all fabrics to determine the best installation order for the entire inventory collection.

In steps 108 and 109, the fabric arrives at its installation day and is placed on the machine. Using GFTS, the user notifies the clothing manufacturer that the fabric has been installed and is currently running. The user can also indicate myriad other factors including ease of installation and startup characteristics. Depending upon the type of customer, the system may automatically enter another order to replace this consumed product.

Another alternative embodiment of the present invention employs an automated phone system where the user can enter a username and password, then the fabric number and is prompted, using the keypad, to enter additional fabric run information such as on or off dates. The system reads back the information and prompts for confirmation.

In step 110, the GFTS notifies all interested customer employees and manufacturer employees of the fabric installation. This notification serves the purpose of enabling others to enter their specific opinions or related comments.

In step 111, the fabric is running through its normal service life. At any point in time, the user can enter additional information about the fabric, its run characteristics, etc.

In step 112 the fabric reaches its schedule or unscheduled end-of-life and is removed from the machine. Using GFTS the customer enters a complete summary of the fabric's performance and final characteristics.

In steps 113 and 114 a piece of the fabric is sent back to the supplier for the analysis in a laboratory. During the analysis process, additional information is entered in GFTS by the laboratory staff. The finished lab report is then made available on-line through GFTS. This lab information may also be used to determine whether a scheduled lifespan of a fabric should be modified, or if a particular machine shows a tendency to shorten or extend fabric life, thus allowing an adjustment in manufacture and order timing for fabric for that particular machine.

In step 115, the fabric and a subset of its run information is placed in a global reference database for all permitted users to access. The database is indexed using all relevant fabric parameters from manufacturing specifications to run characteristics.

In step 116, users located around the world have access to the fabric run information and use it in the process of researching their own future applications as described in step 101.

In step 117, users can access even more detailed information to the run statistics, designs and comments regarding fabrics used within their company worldwide.

The process then ends at step 118. While the processing steps are depicted in a particular order, the sequence of some of these steps may be changed without affecting the outcome of the process.

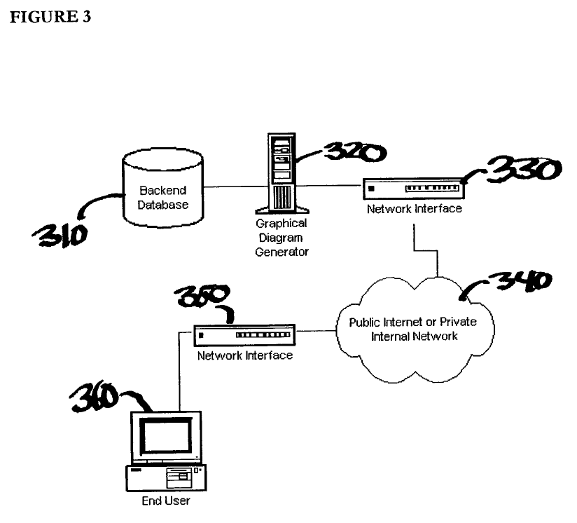

Referring next to FIG. 3, a computerized hardware network interface for implementing the invention is depicted. As is shown in FIG. 3, a backend data base 310 includes all applicable information regarding the current status of various paper machine clothing. This information preferably includes various information inputs as depicted in FIG. 1 being provided by ERP system 20, other computer systems 30, the manual addition of information 40 and various ancillary processing routines 50. Indeed, Graphical Design Generator Algorithm 10 of FIG. 1 functions based upon information stored in back end data base 310.

From this back end data base 310, a Graphical Diagram Generator 320 generates various graphical user interfaces in accordance with the invention. The precise structure of these graphical user interfaces will be described below. These graphical user interfaces are constructed to allow a remote or other user to access the information in a friendly, usable and updateable format.

Network interface 330 interfaces with Graphical Diagram Generator 320 to allow for the presentation of various requested user interfaces to a user via public Internet or private internal network 340. Such a network may comprise any method for transmission and receipt of data between two computing devices. These devices may comprise standard computers, personal digital assistants (PDA's) or any other type of wired or wireless data access device.

In accordance with the present invention, access is provided via an end user computer 360 via a second network interface 350. Thus, network interfaces 330 and 350 assist in the transfer of data between end user 360 and Graphical Diagram Generator 320 via computer network 340 as noted above. In this manner, end user 360 is able to specify, observe, retrieve and provide additional information to graphical diagram generator 320.

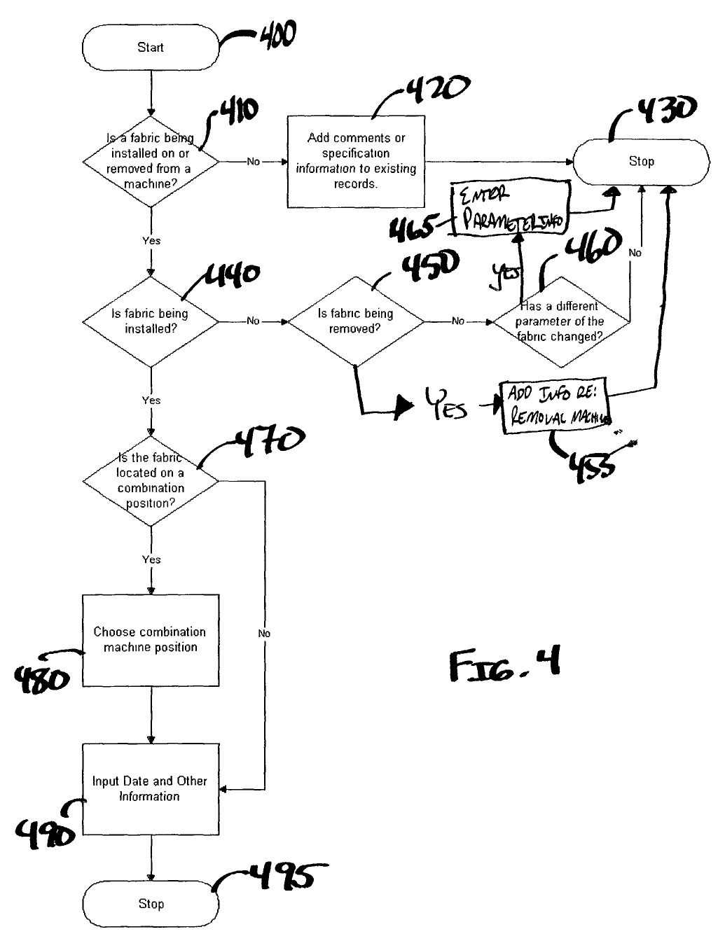

Information to be entered by a user 360 regarding fabric use may be obtained in accordance with a questioning method as set forth in FIG. 4. Referring to FIG. 4, a data entry protocol begins at step 400, and at step 410 a user is asked whether a fabric is being installed or removed from a machine. If this inquiry at step 410 is answered in the negative, and therefore a fabric is not being installed or removed, the user is requested to add comments or specification information to existing records at step 420. Upon entry of this information, processing stops at step 430.

If the inquiry at step 410 is answered in the affirmative, and it is confirmed by a user that fabric is being installed or removed from a machine, processing passes to step 440 where the user is asked whether fabric is being installed. If this inquiry in step 440 is answered in the negative, and therefore fabric is not being installed, processing passes to step 460 where it is questioned whether fabric is being removed. If this inquiry at step 450 is answered in the affirmative, and it is confirmed by the user that a fabric is being removed, control passes to step 455 where the user is requested to answer additional information regarding the removal machine. After entry of this additional information, processing stops at step 430.

If at step 450, the inquiry regarding the fabric being removed is answered in the negative, control then passes to step 460 where the user is asked whether a different parameter of the fabric has changed. If this inquiry is answered in the negative, control processing stops at step 430, and it is determined in accordance with the invention that the information regarding whether fabric is being installed or removed from the machine had been provided incorrectly. If the inquiry at step 460, however, is entered in the affirmative and it is determined that a different parameter of the fabric has changed, at step 465, the user is requested to enter this changed parameter information. After entry, processing passes to step 430 where processing ends.

If the inquiry at step 440 is answered in the affirmative, it is confirmed by the user that fabric is being installed, control passes to step 470 where the user is asked whether the fabric is located on a combination position. If this inquiry at step 470 is answered in the negative, and the user confirms that the fabric is not located on a combination position, control then passes to step 490 where the user is requested to input the date and other appropriate information. If the inquiry at step 470 is answered in the affirmative, and it is therefore determined from the user that the fabric is located on a combination position, control then passes to step 480 where the user is requested to choose the combination machine position. After the selection at step 480, control passes to step 490, and the date and other information are input by the user as noted above. After input of the information at step 490, control passes to step 495 and processing ends. Thus, in accordance with the process as shown in FIG. 4, a user is able to enter various information regarding the use of various papermaking machine fabrics at their plant.

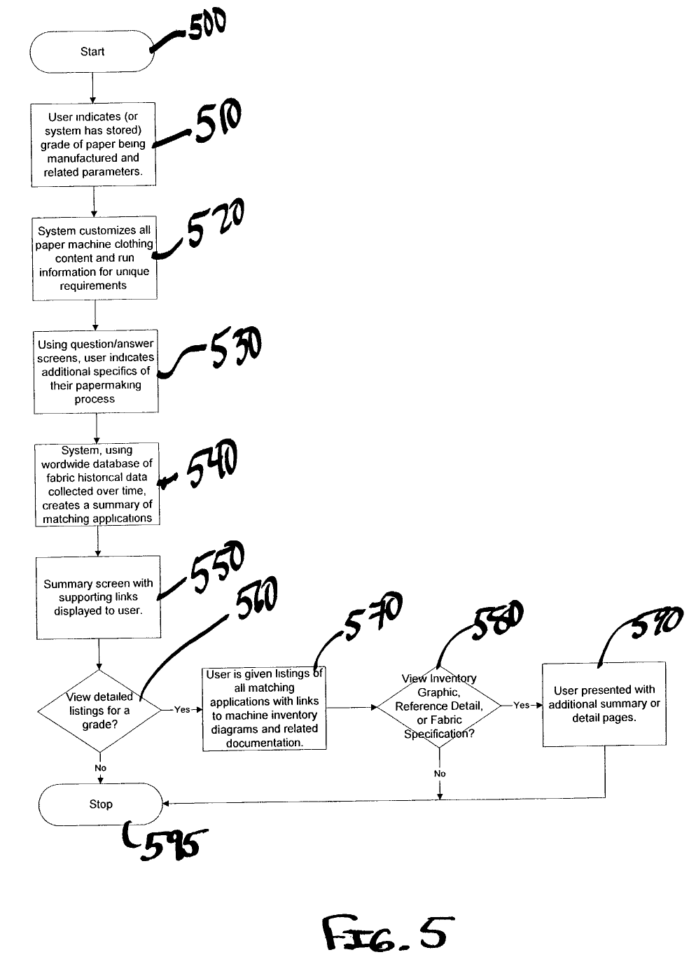

Referring next to FIG. 5, a flowchart of a portion of a query form for requesting various product applications in accordance with the invention is depicted. Thus, in accordance with the flowchart shown in FIG. 5, a user is able to determine a particular product fabric that might be applicable for his or her particular machine and/or application. As is shown in FIG. 5, at step 500 the procedure starts, and in step 510 the user indicates (or the system retrieves from a stored memory) a grade of paper being manufactured by the user and various related parameters regarding the manufacture of that paper. Thereafter, processing continues at step 520 where the system in accordance with the invention automatically customizes all paper machine clothing content and run information for the unique requirements of the user. At step 530 in response to various question and answer screens, the user indicates any additional specifics of their particular papermaking process.

Based upon the answers given by the user, the grade of paper being manufactured, and various additional customizing features obtained in steps 510, 520 and 530, in accordance with the invention, the system searches a worldwide database of fabric historical data collected over time based upon use of various papermaking fabrics and creates a summary of potentially matching applications to that requested by the user. At step 550 a summary screen with click through supporting links for each of the entries is displayed to a user listing the various matching applications described at step 540.

At step 560 a user is asked whether he or she wishes to view detailed listings for a particular grade or application listed in the summary screen at step 550. If this inquiry is answered in the negative, processing continues to step 595 and is stopped.

If the inquiry at step 560 is answered in the affirmative, and it is confirmed that the user wishes to view detailed listings for a particular grade or application, processing continues at step 570 where the user is therefore given a listing of all matching applications with links to machine inventory diagrams and related documentation to allow a user to review various suggestions, and make decisions regarding purchasing and use of a particular fabric for a particular application. After this step, an inquiry is made at step 580 where the user is asked whether he or she wishes to review inventory graphic, reference detail or fabric specification for any particular matching applications, machine inventory diagrams or related documentation. If this inquiry is answered in the negative, control once again passes to step 595 and processing stops.

If the inquiry at step 580 is answered in the affirmative, and it is determined that additional information is to be viewed by a user, processing then passes to step 590 where the user is presented with additional summary or detailed pages as requested. After display of this information, processing passes once again to step 595 and processing ends.

Therefore, in accordance with this portion of the invention, a user is able to utilize a large amount of collected and stored information regarding various papermaking machine fabric applications, and is able to select a particular product for their application based upon information obtained from prior use of others.

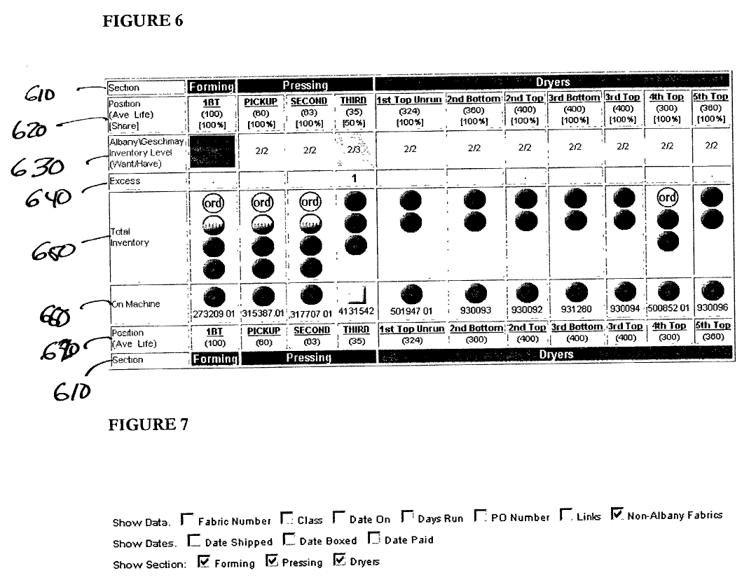

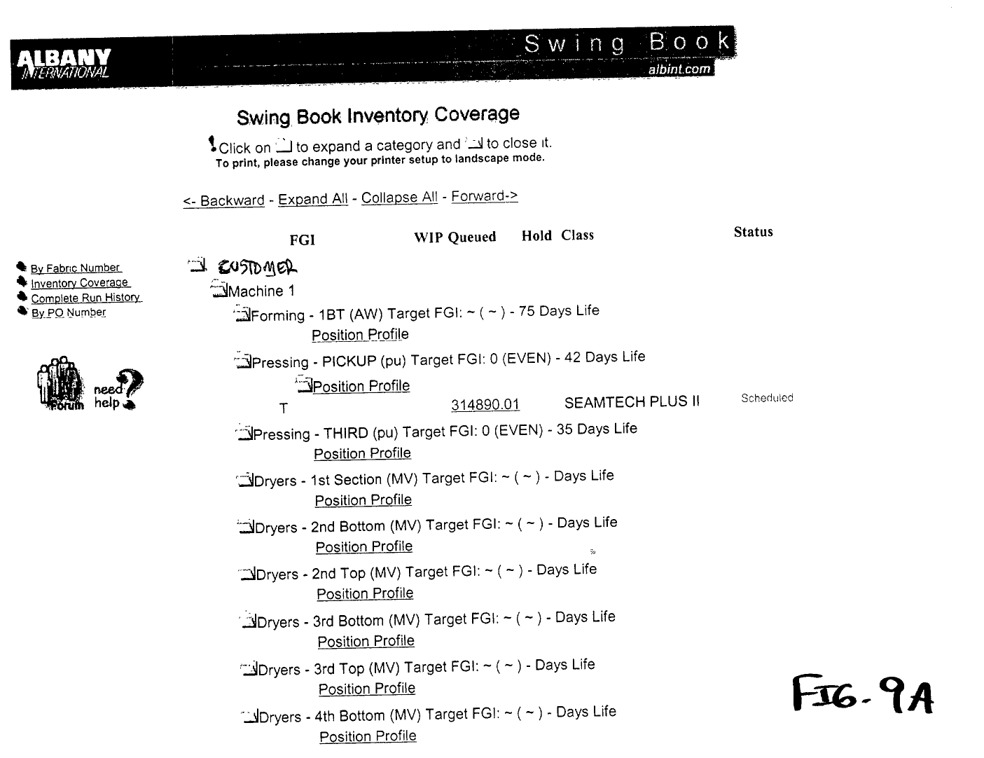

Referring next to FIG. 6, an example of a screen view of a graphical interface in accordance with the invention depicting the various status and location information of the various machine fabrics for a particular client is shown. While a particular number of “status” elements are depicted in the screen views of FIG. 6 (and FIG. 8, as will be described below), any number of status information regarding the current state of a piece of clothing comprising all relevant and supporting documentation may be included, by way of example only. This status information may include the following:

Tracking of time sequence in the supply chain including proposal, order placement and order status, manufacturing status, storage/warehouse information and installation and/or removal status and indication.

Specifications including ordered and actual/finished product specifications.

Used fabric analysis and laboratory reporting including feedback which is channeled into new fabric specifications.

Paper machine operating parameters.

Paper/finished product properties.

Economic analysis of fabric performance.

Amount, degree of industry use and supporting documentation for this fabric style.

Industry documented results with this fabric style.

Technical articles about this fabric style.

Complete “product profile” and marketing summaries.

In-use testing, evaluation and data regarding the fabric while running.

Invoice, payment information.

Emergency delivery need identification.

Planned use in production calendar and position in sequence of fabrics to be placed on machine.

Role in inventory coverage versus target for machine.

Identification of supplier and supporting documentation.

Complete history of past use by paper machine position.

Group discussions with customers on issues, experience and solutions with this fabric and/or this style of fabric.

Personalized and user-controlled email notifications of changes in described documentation.

As is shown in FIG. 6, graphical user information regarding various paper machine fabrics are shown. The screen view of FIG. 6 includes a number of categories, and information regarding various fabrics for each individual machine for a particular client. Thus, a screen view such as that shown in FIG. 6 is provided for each client, multiple screen views being provided if necessary, to accommodate a number of machines or locations. As is shown, a section information portion 610 indicates the section of the papermaking process in which a particular machine resides or a particular portion of a single machine. Thus, as is shown in FIG. 6, section indication 610 lists a forming section, a pressing section and a dryer section. Category indication 620 shows a position, average life and percentage usage by supplier. Thus, as is shown in the forming section, the machine position 1BT has an average life of 100 days and is supplied with 100% of its fabrics from a single supplier. Other positions such as pickup, second and third have different average lives and have different share percentages.

Status indication 630 depicts an inventory level, and includes a ratio of the desired number of fabrics in inventory for a particular machine as compared with the number of fabrics that are actually in inventory. Thus, in the forming section, three fabrics are desired, but only two are in inventory, while at the pickup and second press position, it is desired to have two fabrics in inventory, and two are present. Finally, for the third press position, it is desirable to have two fabrics in inventory, while three are present. Thus, an additional fabric for the 1BT forming position must be processed, while the third press position has an extra fabric in inventory, and therefore, section 460 (excess), indicates one excess fabric for the third press. While this excess may be desirable, if too much excess is provided, because of the large size of these press fabrics, inventory, cost and manufacturing space will be wasted.

Next, graphical representation 650 presents a graphical indication of total inventory and fabric status. Therefore, for example, regarding position 1BT in the forming section, the two solid circles indicate two completed fabrics in inventory. The half filled-in circle with teeth indicates a fabric in process that is partially completed. Furthermore, the circle with the “ORD” included therein, indicates a fabric on order. Additional graphical indications might indicate an open dotted circle for an open inventory position in which no fabric has been ordered, and various other indications, such as whether payment has been made or should be made, or the like. Any other number of indications may be made in accordance with various types and inventory of fabrics.

On machine indication 660 indicates the file number and type of fabric included on each machine. Thus, in forming position 1BT, the fabric produced in accordance with reference number 273290.01 is on the machine. The other reference numbers are similarly indicated. At the bottom of the chart sections 620 and 610 are once again are repeated. This is because in many cases if additional information is explained in the chart, a scrolling function may be necessary in order to view all of the data.

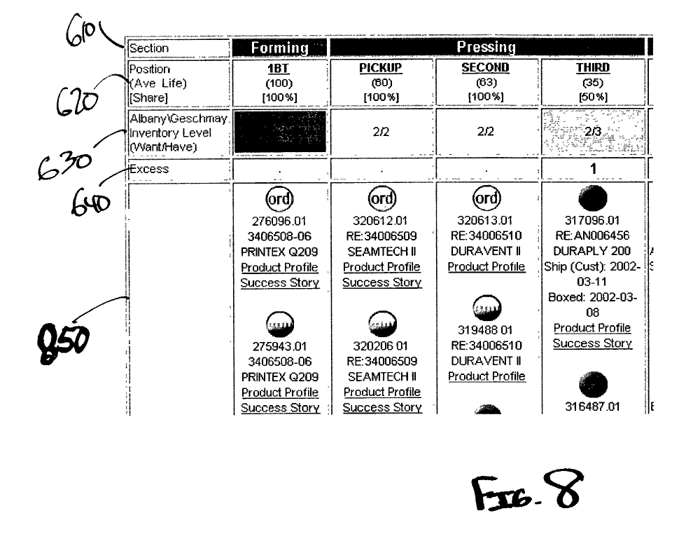

As noted above, additional information (above that shown in FIG. 6) may be displayed to a user. Thus in FIG. 7, a sample of a hide/view selection for the user is shown. In accordance with the selections as shown in FIG. 7, a user may customize the graphical view of the stored information. Various selections may be implemented and as is shown in FIG. 7, the forming, pressing and dryer sections are requested to be shown. Also available may be various data such as fabric number class, date on, days run, and the like, and dates regarding shipping, boxing and payment information, and the like. Further selections may be provided to the user in accordance with information stored in the computer section (backend database 310). This information may be displayed by machine, or by any other organization format desired by a user.

As is shown in FIG. 8, if all of the hide/view selections are checked in FIG. 7, an example of a portion of what might be provided to a user in FIG. 8. As is shown in FIG. 8, the various sections 610, 620, 630 and 640 depict the same information as that in FIG. 6. However, in accordance with the various selected additional information to be viewed, the graphical representation of total inventory in section 650 of FIG. 6 is expanded as shown at section 850 in accordance with the invention. Therefore, at section 850, for each fabric, rather than simply indicating a graphical representation, various reference numbers, file indications, fabric type, and further subcategories of product profile and a success story regarding the particular product may be provided. Furthermore, as is shown in the column regarding the third press, completed products may indicate the date shipped or to be shipped, the date boxed or to be boxed, and any additional information. Therefore, as is shown, various levels of display can be provided for a user, allowing for an overall view such as that shown in FIG. 6, or more detailed graphical information such as that shown in FIG. 8. Furthermore, the additional information in FIG. 8 may allow a click-through for even more detailed information regarding specific entries shown in FIG. 8.

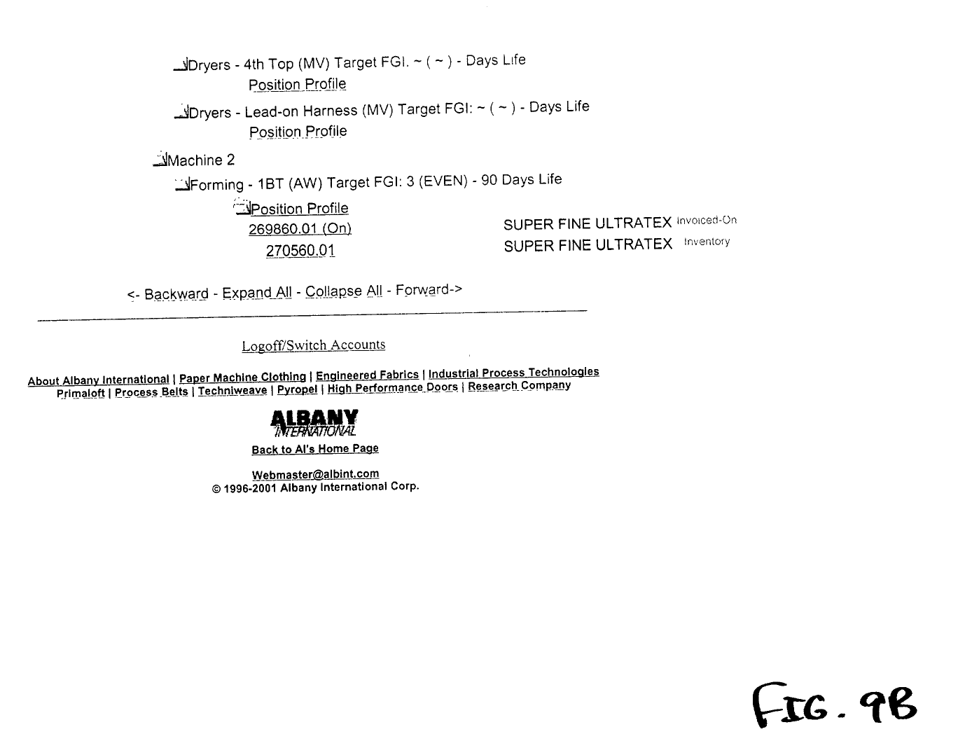

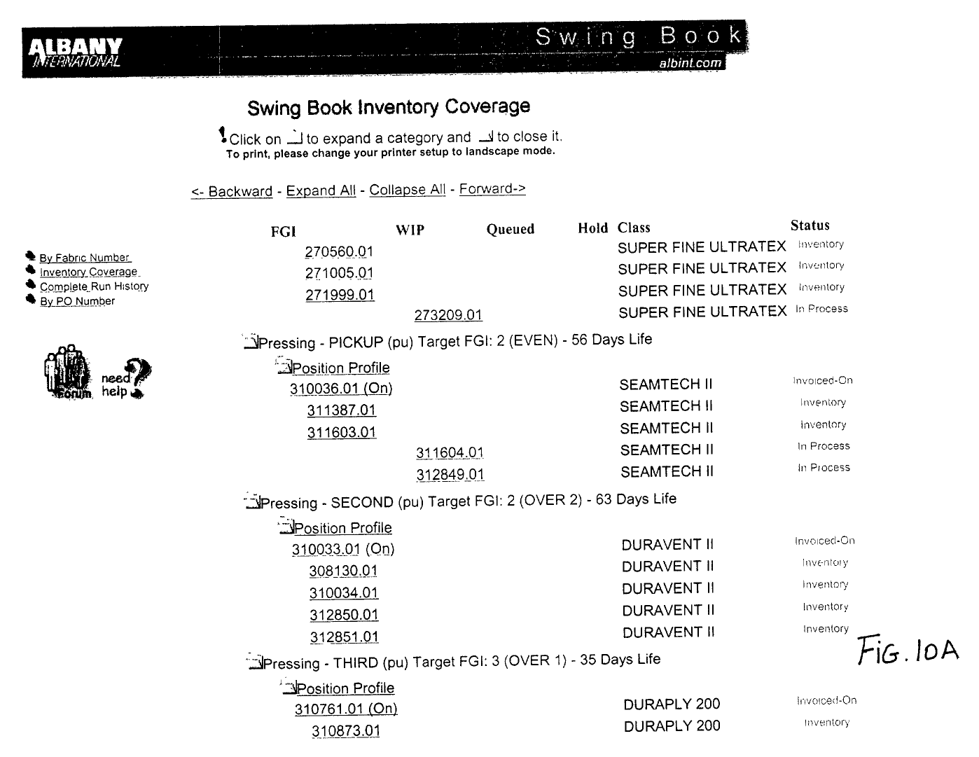

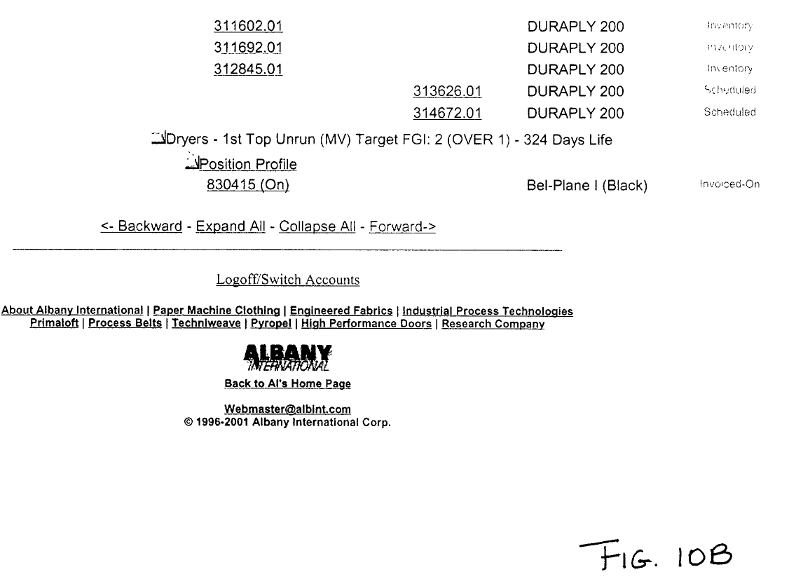

Referring next to FIGS. 9A, 9B, 10A and 10B, additional information that may be provided in accordance with click-through selections from information provided in accordance with graphical user interfaces of FIGS. 6 and 8 will be described. For example, upon selection and click through of the indication of a particular machine, a complete run history of all fabrics included on that machine may be provided. For example, as is shown in FIGS. 9A and 9B, a fabric history includes information regarding each machine and location (such as those shown in FIGS. 6 and 8), and includes a click through position profile for each product. As is shown under the press pickup position, for example, an open position profile depicts a particular fabric, in this case, number 314890.01 which is a SEAMTECH PLUS II fabric and is scheduled to be installed. Similar information regarding different fabrics is shown in FIG. 9B for the forming 1BT position, in which in the position profile, a first fabric is shown as being on the machine, while a second fabric is shown as being in inventory.

In FIGS. 10A and 10B, additional information upon selection of a position profile for each of the machines is shown. For example, for the press pickup position, a first fabric is invoiced and on the machine, a second and third fabric are shown in the finished goods inventory (FGI) category, and are noted as being in inventory. Furthermore, a fourth and fifth fabric are listed as being in the work in process (WIP) category, and are listed as being in process. As is shown in FIG. 10B, a fabric may also be in a queue, and is listed as being “scheduled” as shown in the fourth and fifth fabrics listed in FIG. 10B. Therefore, in accordance with this additional information, via the graphical user interface, in depth detailed information regarding particular fabrics, machines and in-process inventory may be obtained by a user.

Therefore, in accordance with the invention, graphical representations of various paper machine fabrics and their status can be provided to a user, updated and easily utilized to provide various desired information. As noted above, in the past, this information was kept by hand. Thus, the determination of fabrics in inventory, and proper analyzation of fabric for the machines to be produced was very difficult. In this manner, a customer can be assured that fabrics will be available, and the machines will not be down for a lack of proper fabric supply. While this invention has been described with respect to papermaking fabrics, it is equally applicable to other manufacturing forming processes and machines requiring a pre-manufactured fabric to be used, for example, for the production of other non-wovens.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A method for tracking fabrics for use on papermaking machines, comprising the steps of:
determining a status of one or more fabrics for a papermaking machine;
graphically displaying said status; and
modifying said graphical display upon a change in said status.

2. The method of claim 1, wherein said status changes upon entry of information by a user based upon a change in status of a particular fabric.

3. The method of claim 1, wherein said status includes at least a comparison between a number of fabrics in inventory and a number of fabrics desired to be in inventory.

4. The method of claim 3, further comprising the step of ordering a fabric based upon said comparison.

5. The method of claim 1, wherein said status includes at least fabrics on a machine, fabrics in inventory, fabrics being produced, and fabrics on order.

6. The method of claim 5, wherein said graphical display includes a different graphical representation for each fabric's status.

7. The method of claim 1, wherein at least one of said graphical displays allows additional information to be displayed by the selection thereof.

8. The method of claim 7, wherein said additional information includes at least a history of said fabric.

9. A method for tracking fabrics for use on papermaking machines, comprising the steps of:
determining a status of one or more fabrics for a papermaking machine;
determining a status of one or more fabrics in inventory for a papermaking machine; and
beginning fabrication of a new fabric for a papermaking machine based upon said determinations.

10. The method of claim 9, further comprising the step of graphically displaying said determined status.

11. The method of claim 10, further comprising the step of automatically ordering the fabrication of said new fabric based upon said determination.

12. A graphical user interface for tracking fabric status on papermaking machines, comprising:
data receiving means for accepting data regarding one or more fabrics for a papermaking machine; and
display means for graphically displaying and providing access to said status in accordance with said received and related data;
wherein said graphical display is modified based upon a change in said status.

13. The graphical user interface of claim 12, wherein said status changes upon entry of information by a user based upon a change in status of a particular fabric.

14. The graphical user interface of claim 12, wherein said status includes at least a comparison between a number of fabrics in inventory and a number of fabrics desired to be in inventory.

15. The graphical user interface of claim 14, further comprising ordering means for ordering one or more fabrics based upon said comparison.

16. The graphical user interface of claim 12, wherein said status includes at least fabrics on a machine, fabrics in inventory, fabrics being produced, and fabrics on order.

17. The graphical user interface of claim 16, wherein said graphical display includes a different graphical representation for each fabric's status.

18. The graphical user interface of claim 12, wherein at least one of said graphical displays allows additional information to be displayed by the selection thereof.

19. The graphical user interface of claim 18, wherein said additional information includes at least a history of said fabric.

20. A computer program for tracking fabric status on papermaking machines, comprising:
an instruction for determining a status of one or more fabrics for a papermaking machine;
an instruction for graphically displaying and providing access to said status in accordance with said received and related data; and
an instruction for modifying said graphical display upon a change in said status.
